(19) United States
(12) Patent Application Publication
(10) Pub. No.: US 2023/0025606 A1
(43) Pub. Date: Jan. 26, 2023

(54) DRIVE UNIT AND VEHICLE WITH A DRIVE UNIT

(71) Applicant: ZF Friedrichshafen AG, Friedrichshafen (DE)

(72) Inventors: Andreas Holzlöhner, Langenargen (DE); Vyacheslav Brushkivskyy, Kressbronn (DE); Marcel Neurohr, Friedrichshafen (DE)

(73) Assignee: ZF Friedrichshafen AG, Friedrichshafen (DE)

(21) Appl. No.: 17/846,792

(22) Filed: Jun. 22, 2022

(30) Foreign Application Priority Data
Jul. 20, 2021 (DE) 10 2021 207 729.3

(51) Int. Cl. H02K 9/19; H02K 5/12; H02K 7/116; H02K 5/20

(52) U.S. Cl. CPC H02K 9/19; H02K 5/12; H02K 7/116; H02K 5/20

(57) ABSTRACT

The invention relates to a drive unit (1) with a housing (2), an electric motor (3) arranged therein, a transmission (8) coupled to the electric motor (3), at least two oil chambers (15, 16) arranged in the housing (2), which have oil zones (20, 21) and air zones (22, 23) and in which the oil zones (20, 21) are flow-connected to one another by an overflow channel (18). A pump (14) is flow-connected on its suction side with an oil zone (20) and passes oil through the oil chambers (15, 16). A pressure-equalization channel (30) opens into the air zones (22, 23) and flow-connects them to one another.

### RELATED APPLICATIONS

This application claims the benefit of and right of priority under 35 U.S.C. § 119 to German Patent Application No. 10 2021 207 729.3, titled DRIVE UNIT AND VEHICLE WITH A DRIVE UNIT, and filed on Jul. 20, 2021, the contents of which are incorporated herein by reference in its entirety

The invention relates to a drive unit, in particular an electric drive for a vehicle, with a transmission.

### FIELD OF THE DISCLOSURE

Electric drive units with a transmission stage integrated in a housing are known from the prior art. These can comprise a wet-running or a dry-running electric motor and are used in motor vehicles. To ensure reliable operation the drive unit and the transmission stage have to be lubricated. For that purpose, oil from an oil reservoir is pumped through the drive unit with the help of a pump.

### BACKGROUND

The oil reservoir can be separated by a partition wall into two oil chambers, which are located close to the axial ends of the rotor shaft in order to take up the oil from actively lubricated bearings. The two oil chambers are separated from one another by a partition wall which has an overflow channel so that oil can flow from one oil chamber into the adjacent one. By virtue of the two oil chambers, when the drive unit is in an inclined position, for example when driving uphill, not all the oil flows to one end and the movement of the oil is reduced by the partition wall compared with having a single large oil chamber. Components that co-rotate with the rotor shaft are usually located at each end of the shaft, but if there is excess oil in the associated oil chamber, they can take up too much oil and pass it into the upper part of the oil chamber, which is undesirable. Furthermore, if much more oil is present in one oil chamber than in the adjacent one, oil can slosh over abruptly via the overflow channel into the emptier of the oil chambers and penetrate into areas which should not come in contact with oil, or not much oil. Such areas therefore have to be sealed, with additional cost and complexity.

Such drive units comprise, for each oil chamber, vents in order to enable venting to the outside, so that if the oil levels are greatly different or there are large temperature changes in the chambers, the pressure in the air zone cannot become too high or too low, which would at least make it more difficult to pump the oil out of one of the oil chambers.

The disadvantage of these drive units is that their field of use is very restricted, since in certain installation positions or driving situations the pressure equalization toward the outside can be perturbed and the pressure equalization in the air zone of the oil chambers then takes place by way of the overflow channel. Accordingly, such drive units cannot be used for any installation position or driving situation, since for example in the case of particularly inclined installation positions or extreme driving situations oil can slosh over abruptly as far as the vents.

### SUMMARY

The purpose of the present invention is to provide an electric drive unit with a transmission stage integrated in a housing, which avoids the above-mentioned disadvantages and enables a wider field of use than the known drive units.

This objective is achieved by a drive unit with a housing, an electric motor arranged therein, a transmission coupled to the electric motor, at least two oil chambers arranged in the housing, each of them comprising an oil zone and an air zone and being flow-connected with one another by way of an overflow channel, a pump, wherein the pump is flow-connected on its suction side with one oil zone and pumps oil through the oil chambers, and a pressure-equalization channel which opens into the air zones and couples them to enable flow between them and ensure pressure equalization between the said air zones. This ensures pressure equalization for any installation position and driving situation, which increases the field of use of the element drive unit with its transmission stages, since an abrupt sloshing-over of oil from one oil chamber into the other is prevented. Moreover, the pressure in the two oil chambers is always the same, and there is no longer a need to have a vent in each oil chamber. Overall, therefore, the escape of oil is effectively prevented and uniform oil distribution is ensured.

Preferably, the oil zones are arranged at opposite axial end areas of the electric motor. In that way the oil zones can be integrated as simply as possible in the housing of the electric drive unit and the oil zones are close to the places to which oil should be delivered and from which oil flows back to the bottom of the oil chambers.

The pump, for example, delivers oil to bearings of a rotor shaft and/or a transmission and/or to gearwheels of the transmission. Thus, only or preferably those points of the drive unit are supplied with oil, which have to be actively lubricated.

Preferably, the rotor shaft is in the form of a hollow shaft and the pump delivers oil through the hollow shaft. In that way oil from one oil chamber close to the bearing is delivered to the bearings in the other oil chamber. The oil can easily be diverted from the hollow shaft to the bearings and gearwheels.

Preferably, at least one partition wall is provided between the oil chambers, which partition comprises an overflow channel.

Preferably, the electric motor is arranged in a motor space separated from the oil chambers. In that way a dry-running electric motor can be used and the oil does not get to the rotor and stator of the electric motor.

Advantageously the pressure-equalization channel, which opens into the air zones of the oil chambers and flow-connects these with one another, is positioned in the housing in such manner that any penetration of oil into the pressure-equalization channel is prevented and the flow-connection between the air zones of the oil chambers is ensured. For example, the opening points into the air zones of the oil chambers are positioned far away from the oil zones of the oil chambers or behind projections or ribs of the housing whereby a penetration of oil into the pressure-equalization channel is prevented.

In a preferred design, the pressure-equalization channel is protected against the ingress of oil from the oil chambers by mechanical screening. This ensures that the pressure-equalization channel, which carries only air, is free from oil in any installation position and driving situation and the pressure equalization between the oil chambers is not impeded.

In a preferred design the said screening, in particular at both opening points into the air zones, is in the form of a membrane permeable to air but impermeable to oil, or a screening wall in each oil chamber, in particular a labyrinth-type screen. Thus, by simple means a penetration of oil into the pressure-equalization channel is prevented while the flow-connection between the air zones of the oil chambers is ensured.

In an example embodiment, the pressure-equalization channel is formed by a separate air line, in particular a tube or a flexible pipe, which can extend completely inside the housing or partially outside the housing or completely outside the housing. In that way a particularly simple structure is produced. It is conceivable that such a flexible pipe or such a tube can be retrofitted into a known drive unit.

In a further example embodiment, the pressure-equalization channel is formed by a duct in the wall of the housing. In that way no further component is needed. In this case the housing, is preferably of multi-component design so that the duct can be produced as simply as possible, for example by boring or during the casting process. However, it is also conceivable that, except for a cover, the housing is of single-component design, and the duct is integrated in the housing for example with the help of a generative production process.

In a further design the overflow channel and the pressure-equalization channel merge into one another and form sections of a common connecting channel, wherein when the motor has been fitted the overflow channel forms the lower part of the said connecting channel and the pressure-equalization channel is above it. In that way pressure equalization between the air zones of the oil chambers can be ensured without having to produce an additional channel. In this case the oil level is preferably chosen and the connecting channel arranged in such manner that the oil never fills the connecting channel completely in any driving conditions and installation positions.

The proposed drive unit serves to drive a vehicle electrically. Correspondingly, the drive unit comprises an electric motor to supply the drive power for the vehicle. The vehicle can for example be a passenger car or a utility vehicle. The utility vehicle can be a truck, a small van or an omnibus.

### BRIEF DESCRIPTION OF THE DRAWINGS

Further features and advantages of the invention emerge from the following description of preferred embodiments, with reference to the figures which show:

FIG. 1: A sectioned view of an embodiment of the drive unit according to the invention, in which the pressure-equalization channel is formed by a separate air line which extends completely inside the housing,

FIG. 2: A sectioned view of a further embodiment of the drive unit according to the invention, in which the pressure-equalization channel is formed by a separate air line which extends partially outside the housing, and

FIG. 3: A sectioned view of a further embodiment of the drive unit according to the invention, in which the pressure-equalization channel is formed by a duct in the wall of the housing.

### DETAILED DESCRIPTION

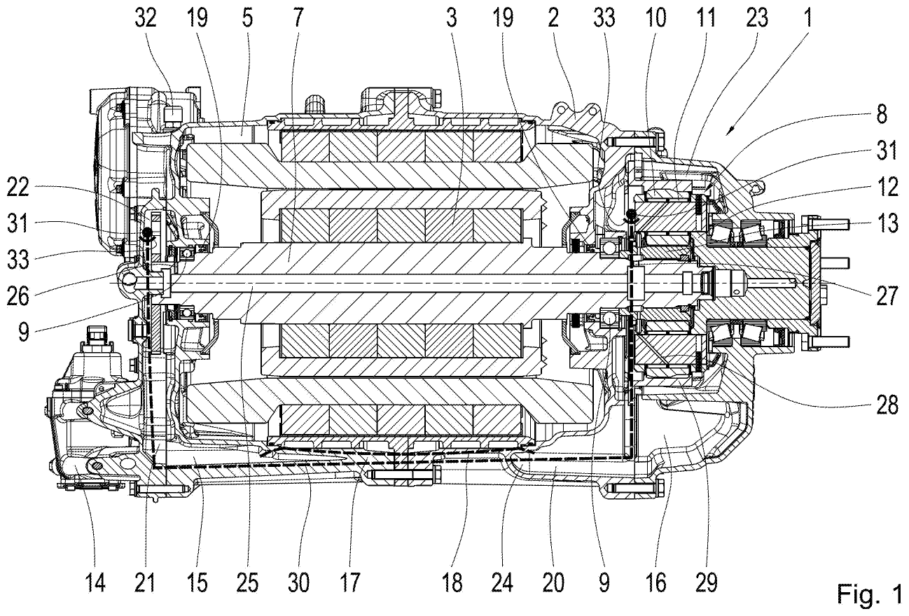

FIG. 1 shows a drive unit 1 according to the invention, with a housing 2 and an electric motor 3 inside a motor space 5 arranged in, but separate and sealed from the housing 2. The electric motor 3 can be for example an asynchronous motor with a stator and a rotor.

In the example embodiment shown, the rotor shaft 7 is in the form of a hollow shaft. To the rotor shaft 7 is coupled a transmission 8, in this case in the form of a planetary transmission. However, it is also possible to use other types of electric motors and transmissions in the drive unit 1.

The rotor shaft 7 is supported in the housing by bearings 9. In the example embodiment shown, the bearings 9 are in the form of ball bearings.

The planetary gearwheels 10 of the transmission 8 are supported by bearings 11 on a planetary carrier 12. In contrast, in this example embodiment the bearings 11 of the planetary gearwheels 10 are needle bearings.

The rotor shaft 7 can be driven by the electric motor 3 and, in the embodiment shown, transmits the torque to a sun gear 13 of the transmission 8. The drive output takes place by way of the planetary carrier 12.

A pump 14 is arranged on the outside of the housing 2. This pump is an oil pump.

Two oil chambers 15, 16 are arranged in the housing 2. Depending on the drive unit concerned, however, it is possible for more than two oil chambers to be present. These oil chambers 15, 16 are separated from one another by a partition wall 17 and are flow-connected by a (symbolically represented) overflow channel 18. The partition wall 17 is arranged in the housing 2 in an area approximately at the axial middle of the electric motor 3.

Furthermore, the oil chambers 15, 16 are separated from the motor space 5 of the electric motor 3 by seals 19.

In this case the oil chambers 15, 16 are positioned at the axial end areas of the electric motor 3, where the bearings 9, 11 and the transmission 8 are also arranged. The overflow channel 18 forms an additional flow-connection between the oil chambers 15, 16.

The oil chambers 15, 16 comprise, respectively oil zones 20 or 21 below and air zones 22, 23 above them.

In the example embodiment shown, the pump 14 draws oil from the oil zone 20 of the oil chamber 16 by way of a suction channel 24 of its own that begins in the oil chamber 16.

The suction channel 24 is a separate channel, which is a distance away from the overflow channel 18 and leads directly alongside the oil chamber 15 to the pump 14.

The pump 14 delivers the oil into a channel 25 inside the rotor shaft 7, which for that purpose is made as a hollow shaft. The two oil chambers 15, 16 are additionally connected to one another by way of this channel 25.

From the channel 25 an opening 26 leads to the bearing 9 in the oil chamber 15, so that the oil is directed to the corresponding bearing and lubricates and cools it.

Oil flowing away from the bearing 9 is then already in the oil chamber 15 and can flow into its oil zone.

At the opposite end of the rotor shaft 7 a further opening 27 is provided, by way of which the oil can get on the one hand to the bearing 9 in the oil chamber 16 and on the other hand to the planetary gearwheels 10 and hence also to the sun gear 13 and, via openings 28, to the bearings 11 of the planetary gearwheels 10. The teeth of a ring gear 29 of the planetary transmission are also lubricated thereby.

Here, too, the oil can then flow down within the oil chamber 16 and into the oil zone 21. From there it is drawn up by the pump 14 again, so that a cycle is produced.

In the embodiment shown in FIG. 1 a pressure-equalization channel 30 is provided, which flow-connects the air zones 22, 23 of the two oil chambers 15, 16 with one another. The pressure-equalization channel 30 is represented by a broken line and extends completely inside the housing 2 and can in that case be in the form, for example, of a tube or a flexible pipe. If necessary, the said tube or flexible pipe can be passed through the overflow channel 18 without overly limiting its cross-section.

The ends and thus opening points 31 of the pressure-equalization channel 30 open into the air zones 22, 23 of the oil chambers 15, 16 and thereby ensure that pressure equalization takes place between the oil chambers 15, 16. If such a pressure-equalization channel 30 is used, it is not necessary for both of the oil chambers 15, 16 to be provided with vents. It is then sufficient for one of the two oil chambers 15, 16 to be provided with a vent 32.

The opening points 31 of the pressure-equalization channel 30 are provided with (symbolically represented) mechanical screening 33 which prevents the oil from making its way into the pressure-equalization channel 30. The mechanical screening 33 can for example be in the form of a membrane which is permeable to air but impermeable to oil. Such a membrane can, for example, be arranged at the end of the pressure-equalization channel 30. In that way air can pass through the pressure-equalization channel 30 so as to ensure pressure equalization, but oil is held back by the membrane.

It is also conceivable to make the mechanical screening 33 in the form of a labyrinth-type screen wall. Such a screen wall can for example be arranged directly at the opening points 31 of the pressure-equalization channel 30, or it can be part of the wall of the housing 2. The labyrinthine structure prevents the oil from getting into the pressure-equalization channel 30, whereas air can pass through such a labyrinth-type screen and can thereby ensure pressure equalization between the oil chambers 15, 16.

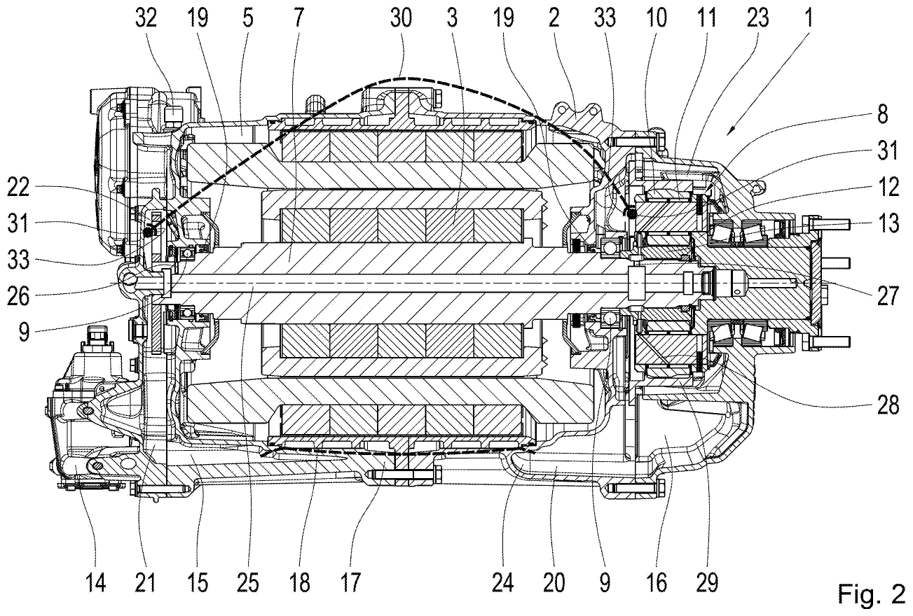

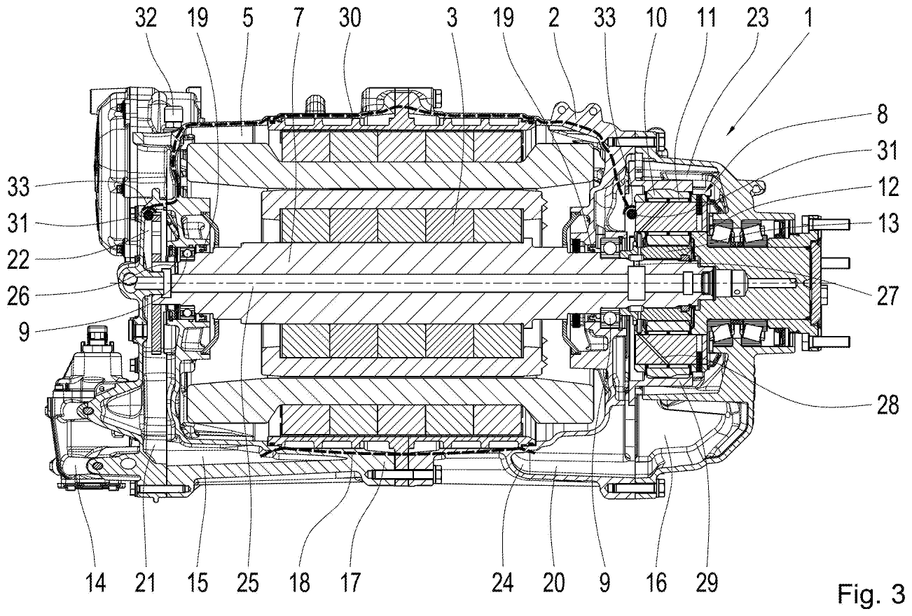

FIGS. 2 and 3 show further embodiments of a drive unit 1 according to the invention. Their functions in principle correspond to the function of the embodiment shown in FIG. 1. Accordingly, in what follows only the differences will be described.

In the embodiment of FIG. 2 the pressure-equalization channel 30 is arranged partially outside the housing 2. Thus, in a very simple manner a tube or flexible pipe connection can be made between the air zones 22, 23 of the oil chambers 15, 16. In this case it should be noted that here, too, the opening points 31 of the pressure-equalization channel 30 open into the air zones 22, 23 of the oil chambers 15, 16.

In FIG. 3 the pressure-equalization channel 30 is in the form of a duct in the wall of the housing 2. In this case the housing 2 is preferably made as a multi-component structure in order thereby to produce the pressure-equalization channel 30 as simply as possible, for example by boring or during the casting of the housing 2, or by means of a generative production process of the housing 2. In that case, the housing 2 can be made as one piece apart from a cover.

In a further embodiment (not shown), the overflow channel 18 and the pressure-equalization channel 30 merge into one another and form sections of a common connecting channel, wherein, in the installed condition of the drive unit 1, the overflow channel 18 forms the lower part of the connecting channel and the pressure-equalization channel 30 is above it.

The overflow channel 18 is thus in the oil zones 20, 21 and the pressure-equalization channel 30 above it is in the air zones 22, 23. Thus, pressure-equalization can be ensured without having to make an additional channel. In this case the oil level is chosen such that, and the connecting channel is arranged in such manner that, in any of the usual inclined positions of the vehicle the oil never fills the whole of the connecting channel and the pressure-equalization channel 30 is always there.

### INDEXES

1 Drive unit
2 Housing
3 Electric motor
5 Motor space
7 Rotor shaft
8 Transmission
9 Bearing
10 Planetary gearwheels
11 Bearing
11 Planetary carrier
13 Sun gear
14 Pump
15 Oil chamber
16 Oil chamber
17 Partition wall
18 Overflow channel
19 Seals
20 Oil zone
21 Oil zone
22 Air zones
23 Air zone
24 Suction channel
25 Channel
26 Opening
27 Opening
28 Openings
29 Ring gear
30 Pressure-equalization channel
31 Opening points
32 Vent
33 Screen

1-12. (canceled)

13. A drive unit for an electric vehicle, the drive unit comprising:
a housing (2);
an electric motor (3) arranged in the housing;
a transmission (8) coupled to the electric motor (3);
a first oil chamber (15) arranged in the housing and defining a first oil zone (21) and a first air zone; (22)
a second oil chamber (16) arranged in the housing and defining a second oil zone (20) and a second air zone (23);
an overflow channel (18) fluidly connecting the first oil zone (21) to the second oil zone (20);
a pump (14) having a suction side flow-connected the second oil zone (20), the pump configured to deliver oil through the first oil chamber (15) and the second oil chamber (16); and
a pressure-equalization channel (30) open to and fluidly connecting the first air zone (22) to the second air zone (23), the pressure-equalization channel configured to equalize pressure between the first air zones (22) and the second air zone (23).

14. The drive unit (1) according to claim 1, wherein the first oil zone (20) and the second oil zone (21) are provided at opposite axial end areas of the electric motor (3).

15. The drive unit (1) according to claim 1, wherein the pump (14) is configured and arranged to deliver oil to bearings (9, 11) of a rotor shaft (7) and/or to bearings of a transmission (8) and/or to gearwheels of the transmission (8).

16. The drive unit (1) according to claim 15, characterized in that, the rotor shaft (7) is in the form of a hollow shaft and the pump (14) is configured and arranged to pump oil through the hollow shaft.

17. The drive unit (1) according to claim 1, comprising a partition wall (17) between the first oil chamber (15) and the second oil chamber (16), the partition wall (17) including at least part of the overflow channel (18).

18. The drive unit (1) according to claim 1, characterized in that the electric motor (3) is arranged in a motor space (5) separated from the oil chambers (15, 16).

19. The drive unit (1) according to claim 1, comprising mechanical screening (33) between the pressure-equalization channel (30) and the first oil chamber (15) and/or between the pressure-equalization channel (30) and the second oil chamber (16) so as to prevent ingress of oil from the respective first oil chamber (15) and/or second oil chamber (16).

20. The drive unit (1) according to claim 19, wherein the mechanical screening (33) is located at a first opening point (31) and a second opening point (31) of the pressure-equalization channel (30).

21. The drive unit of claim 20, wherein the mechanical screening in the form of a membrane permeable to air but impermeable to oil or a screening wall.

22. The drive unit of claim 21, wherein the mechanical screening is formed as a labyrinth-type screen.

23. The drive unit (1) according to claim 1, wherein the pressure-equalization channel (30) is defined by a separate air line.

24. The drive unit (1) according to claim 23, wherein the pressure-equalization channel (30) comprises a flexible pipe.

25. The drive unit (1) according to claim 23, wherein the separate air line extends completely inside the housing (2).

26. The drive unit (1) according to claim 1, wherein the pressure-equalization channel (30) is formed by a duct in a wall of the housing.

27. The drive unit (1) according to claim 1, wherein the overflow channel (18) and the pressure-equalization channel (30) merge into one another and together form one or more sections of a common connecting channel, such that in the installed condition of the motor the overflow channel (18) is in a lower part of the common connecting channel and the pressure-equalization channel (30) is in an upper part of the common connecting channel.

28. A vehicle comprising the drive unit (1) according to claim 13.

29. The vehicle according to claim 28, wherein the first oil zone (20) and the second oil zone (21) are provided at opposite axial end areas of the electric motor (3).

30. The vehicle according to claim 29, characterized in that the rotor shaft (7) is in the form of a hollow shaft and the pump (14) is configured and arranged to pump oil through the hollow shaft.

31. The vehicle according to claim 30, comprising a partition wall (17) between the first oil chamber (15) and the second oil chamber (16), the partition wall (17) including at least part of the overflow channel (18).

32. The vehicle according to claim 31, wherein the overflow channel (18) and the pressure-equalization channel (30) merge and together form one or more sections of a common connecting channel, such that in the installed condition of the motor the overflow channel (18) is in a lower part of the common connecting channel and the pressure-equalization channel (30) is in an upper part of the common connecting channel.
